(19) United States
(12) Patent Application Publication
(10) Pub. No.: US 2011/0271933 A1
(43) Pub. Date: Nov. 10, 2011

(54) FORCED INDUCTION SYSTEM FOR AN INTERNAL COMBUSTION ENGINE

(76) Inventors: Scott Snow, Commerce, MI (US); James Wilson, White Lake, MI (US)

(21) Appl. No.: 13/079,474

(22) Filed: Apr. 4, 2011

Related U.S. Application Data
(60) Provisional application No. 61/320,391, filed on Apr. 2, 2010.

(51) Int. Cl. F02B 33/12; F02B 75/02

(52) U.S. Cl. 123/318

(57) ABSTRACT

A forced induction system for an internal combustion engine that includes at least one cylinder and at least one piston that is positioned in the cylinder. Valves are linked with the cylinder that allows ingress and egress of a fluid. At least one accumulation chamber is positioned external relative to the cylinder and accommodates fluid exiting an under piston volume. During a four-stroke combustion cycle of the engine, two charges of fluid from the under piston volume are introduced in an above piston volume during the intake stroke of the engine increasing an efficiency of the engine.

### CROSS-REFERENCE TO RELATED APPLICATIONS

This application claims priority of U.S. Provisional Patent Application Ser. No. 61/320,391 filed Apr. 2, 2010, which is incorporated herein by reference.

### FIELD OF THE INVENTION

The invention relates to internal combustion engines.

### BACKGROUND OF THE INVENTION

Internal combustion engines are used in various applications to provide a driving force. Typically such engines include a piston and cylinder arranged to operate through a combustion cycle. During the combustion cycle, fuel and air is generally compressed and ignited to provide energy for driving a piston. There is a need in the art for an improved efficiency internal combustion engine such that a greater amount of energy can be produced for a given engine weight and/or volume. There is also a need in the art for a simple, improved efficiency internal combustion engine that increases power and power density without the need for complicated enhanced induction structures such as turbochargers or superchargers. There is also a need in the art for an improved efficiency internal combustion engine that is economical to manufacture, maintain and operate as well as provides an increased performance characteristic in comparison to an engine having an equal weight and/or volume.

### SUMMARY OF THE INVENTION

In one aspect, there is disclosed a forced induction system for an internal combustion engine that includes at least one cylinder and at least one piston that is positioned in the cylinder. Valves are linked with the cylinder that allows ingress and egress of a fluid. At least one accumulation chamber is positioned external relative to the cylinder and accommodates fluid exiting an under piston volume. During a four-stroke combustion cycle of the engine, two charges of fluid from the under piston volume are introduced in an above piston volume during the intake stroke of the engine increasing an efficiency of the engine.

In another aspect, there is disclosed a forced induction system for an internal combustion engine that includes at least one cylinder and at least one piston positioned within the cylinder. At least one first valve is linked with the cylinder and positioned below the piston allowing entrance of a fluid in an under piston volume. At least one second valve is linked with both the cylinder and the accumulation chamber and is positioned below the piston allowing exit of a fluid in the under piston volume. An accumulation chamber is positioned external relative to the cylinder and accommodates fluid exiting the under piston volume. At least one third valve is linked with both the cylinder and the accumulation chamber and is positioned above the piston allowing transfer of a fluid from the accumulation chamber into an above piston volume. At least one fourth valve is linked with the cylinder and positioned above the piston allowing exit of fluid from the above piston volume. During a four-stroke combustion cycle, two fluid charges from an under piston volume are combined in the accumulator chamber and introduced into an above piston volume during the intake stroke, increasing an efficiency of the engine.

### BRIEF DESCRIPTION OF THE DRAWINGS

FIG. 1 is one embodiment of one internal combustion engine including a piston and cylinder;

FIGS. 2, 3, and 4 are sectional views of the embodiment of FIG. 1 of an engine during an initial compression stroke of the above piston volume and induction of a fluid in an under piston volume;

FIGS. 5, 6, 7, and 8 are sectional views of an internal combustion engine during a combustion stroke in which a fluid in an above piston volume is ignited driving the piston and wherein fluid positioned in an under piston volume is compressed into an accumulation chamber;

FIGS. 9, 10, and 11 are sectional views of an internal combustion engine during an exhaust stroke in which the over piston volume is released following the combustion and a fluid is introduced into the under piston volume;

FIGS. 12, 13, and 14 are sectional views of an internal combustion engine detailing an intake stroke in which a double charge including the compressed fluid in the accumulation chamber and the under piston volume are introduced into an over piston volume;

FIGS. 15, 16, and 17 are sectional views of an internal combustion engine detailing a compression stroke in which an over piston volume is compressed and a fluid is introduced into an under piston volume;

FIGS. 18, 19, 20 and 21 are sectional views of an internal combustion engine detailing a combustion stroke in which a compressed over piston volume is ignited and the under piston volume is transferred into an accumulation chamber;

FIGS. 22, 23 and 24 are sectional views of an internal combustion engine detailing an exhaust stroke in which an above piston volume is evacuated from the cylinder followed by induction of a fluid into an under piston volume;

FIG. 25 is a perspective view of an alternative embodiment of an internal combustion engine including a crankshaft and connecting rod linked with a piston disposed in a cylinder;

FIGS. 26 and 27 are perspective and sectional views of an alternative embodiment of an internal combustion engine including a crankshaft and connecting rod coupled with a piston and including a seal about the connecting rod; and

FIG. 28 is a perspective view of an alternative embodiment of an internal combustion engine including a crankcase, connecting rod and under piston volume valves; and

FIG. 29 is a sectional view of an alternative embodiment of an internal combustion engine including a scotch-yoke.

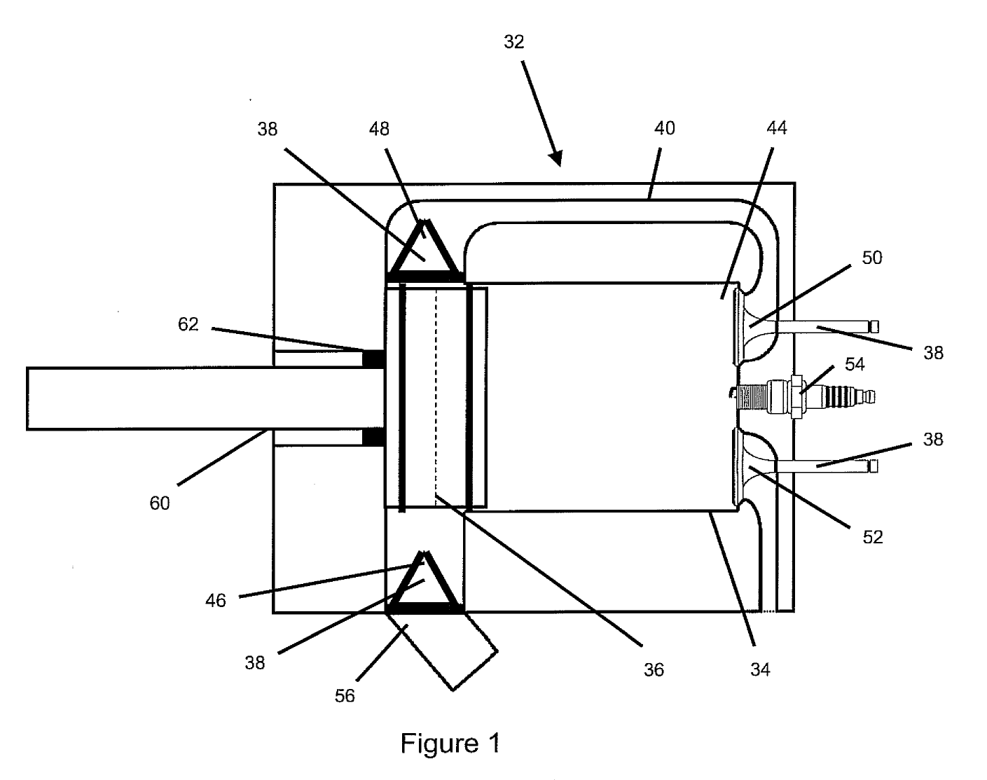

### DETAILED DESCRIPTION OF THE PREFERRED EMBODIMENTS

Referring to the various figures, there are shown various embodiments of an internal combustion engine that includes a forced induction system 32. The forced induction system 32 includes at least one cylinder 34 with at least one piston 36 positioned in the cylinder 34. Valves 38 are linked with the cylinder 34 and allow ingress and egress of a fluid. At least one accumulation chamber 40 is positioned external relative to the cylinder 34 and accommodates fluid exiting an under piston volume 42. During a four-stroke combustion cycle of the engine, two fluid charges from an under piston volume 42 are combined in the accumulator chamber 40 and introduced into an above piston volume 44 during the intake stroke, increasing an efficiency of the engine. In one aspect, the valves 38 may be of various types including reed, poppet and rotary valves. In one aspect, the valves include at least one first valve 46 linked with the cylinder 34 and positioned below the piston 36 that allows entrance of a fluid in an under piston volume 42. The valves 38 may also include at least one second valve 48 linked with both the cylinder 34 and the accumulation chamber 40 and positioned below the piston 36 allowing exit of a fluid in the under piston volume 42. Additionally, the valves 38 may include at least one third valve 50 that is linked with both the cylinder 34 and the accumulation chamber 40. The third valve 50 is positioned above the piston 36 and allows transfer of fluid in the accumulation chamber 40 into an above piston volume 44. Further, at least one fourth valve 52 may be linked with the cylinder 34 and positioned above the piston 36 allowing exit of a fluid from the above piston volume 44.

The forced induction system 32 may also include an ignition device 54 positioned within the cylinder 34 to ignite a fluid within the cylinder 34. In one aspect, the ignition device 54 may include spark plugs, plasma ignition systems, or alternatively no ignition device may be present when the fluid such as a diesel fuel may be ignited by a compression of the fluid.

The forced induction system may also include at least one fuel port 56 linked with the cylinder 34 that allows entrance of a fuel into the cylinder 34. The fuel port 56 may be formed in various locations in the cylinder 34 such as in an above piston volume 44 as well as in an under piston volume 42. The fuel port may additionally be formed in both the above and under piston volumes 44, 42.

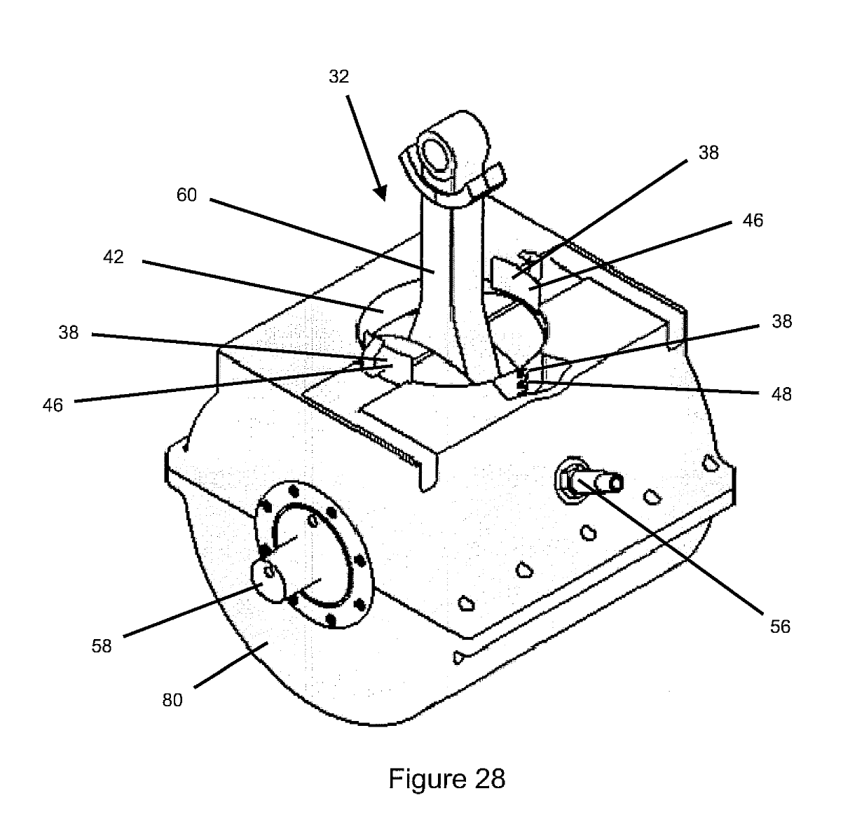

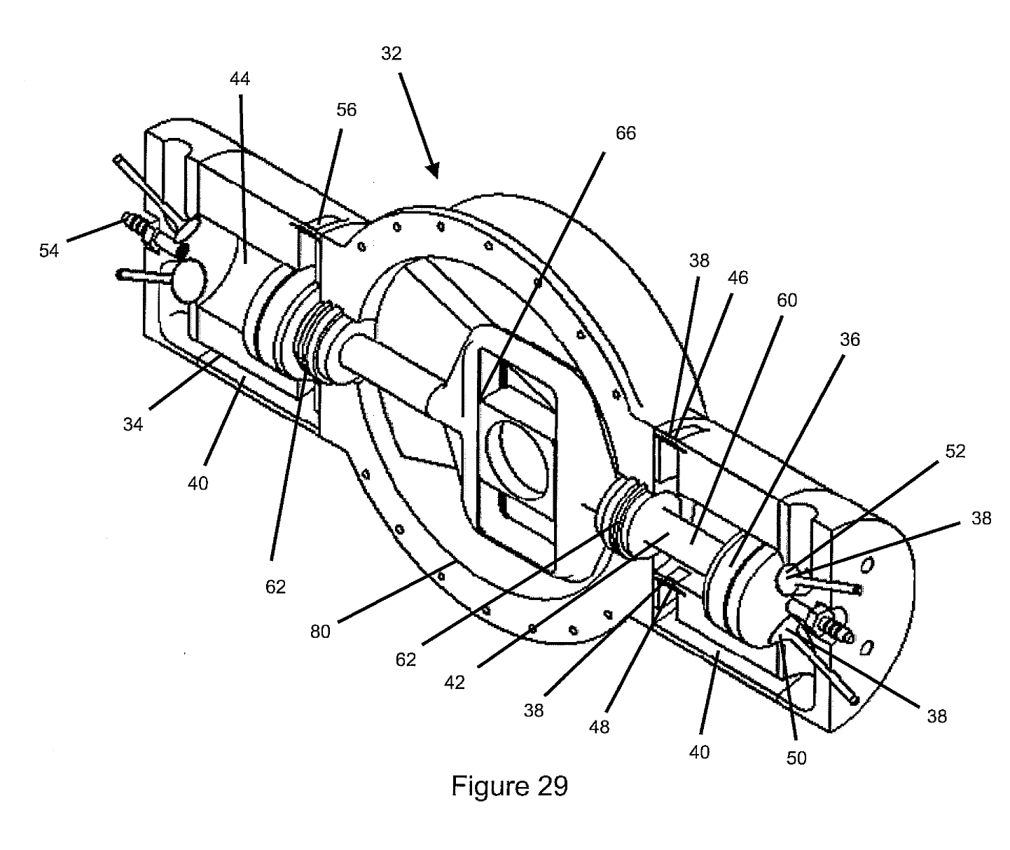

Various types of internal combustion engines may be included in the forced induction system 32 of the present invention. For example, an engine including a scotch-yoke 66 or similar mechanism may be utilized as depicted in the FIG. 29. Additionally, alternative internal combustion engines that may include a crankshaft 58 and connecting rod 60 linked with a piston 36 may also be utilized as shown in the FIG. 28. In one aspect, various engines may include a plurality of cylinders and pistons where each piston 36 and cylinder 34 is isolated from another piston 36 and cylinder 34. In this manner, the fluid charges in an under piston volume 42 are prevented from being released into adjacent or other cylinder volumes

In one aspect, the forced air induction system 32 may include a sealing structure 62 that seals the under piston volume 42 from the crankcase volume 80. The sealing structure 62 may include various gaskets and seals as well as a housing that surrounds the connecting rod 60.

Lubrication for the internal combustion engine may be provided in various locations and utilizing various fluids and structures. In one aspect, the lubricant may be conventionally supplied in a crankcase 80 volume and separated from an under piston volume 42 by a sealing structure 62. Additionally, the lubricant may be supplied in a fuel mixture or fluid that is introduced into the engine in the under piston volume 42 and/or the crankcase 80 volume as well as the above piston volume 44. Further, lubricant may be provided by a high lubricity heavy fuel such as JPS (Jet Propellant 8) and pump diesel.

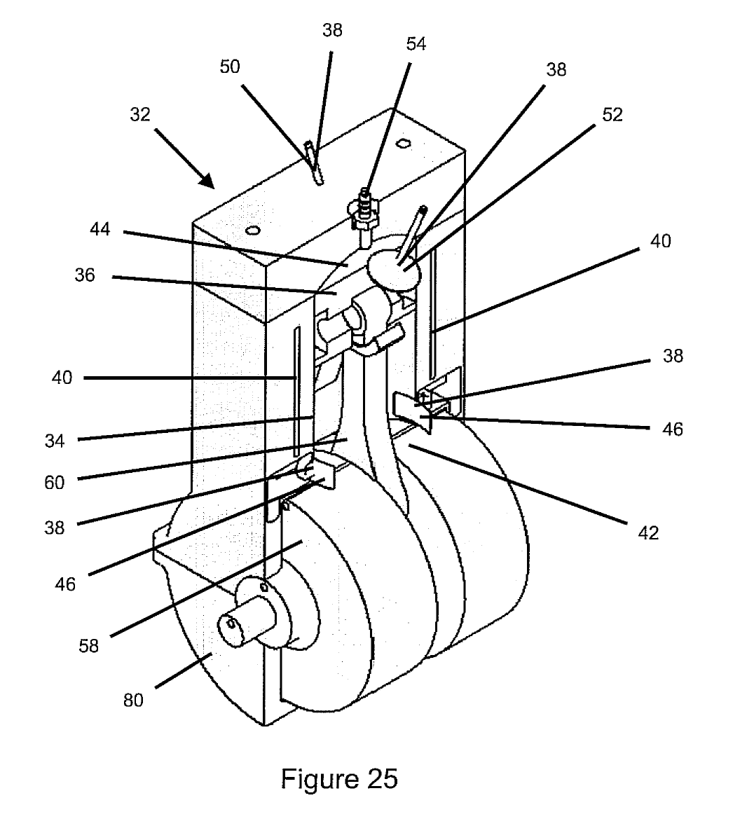

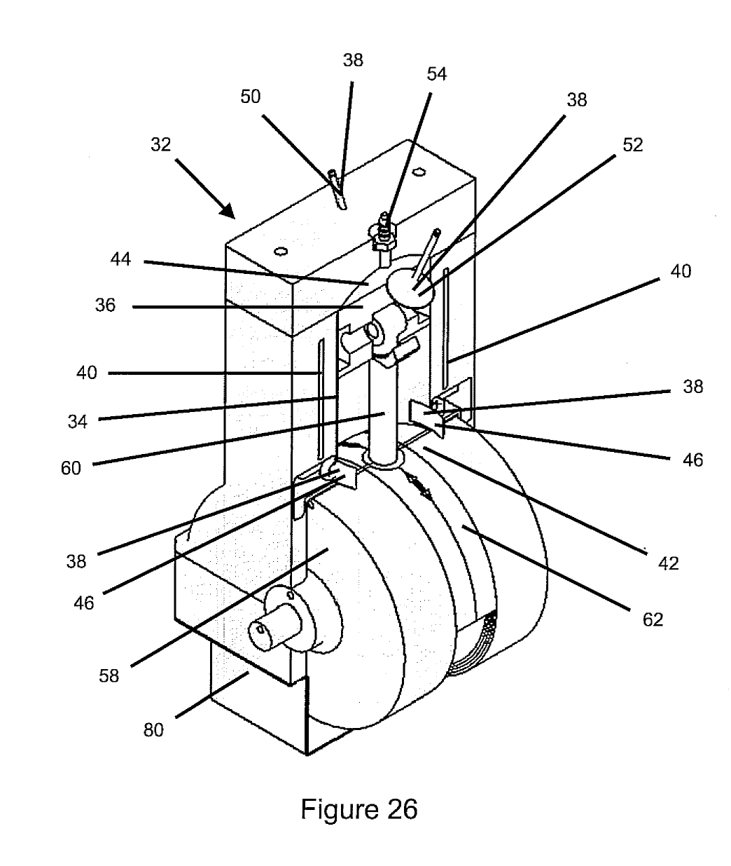

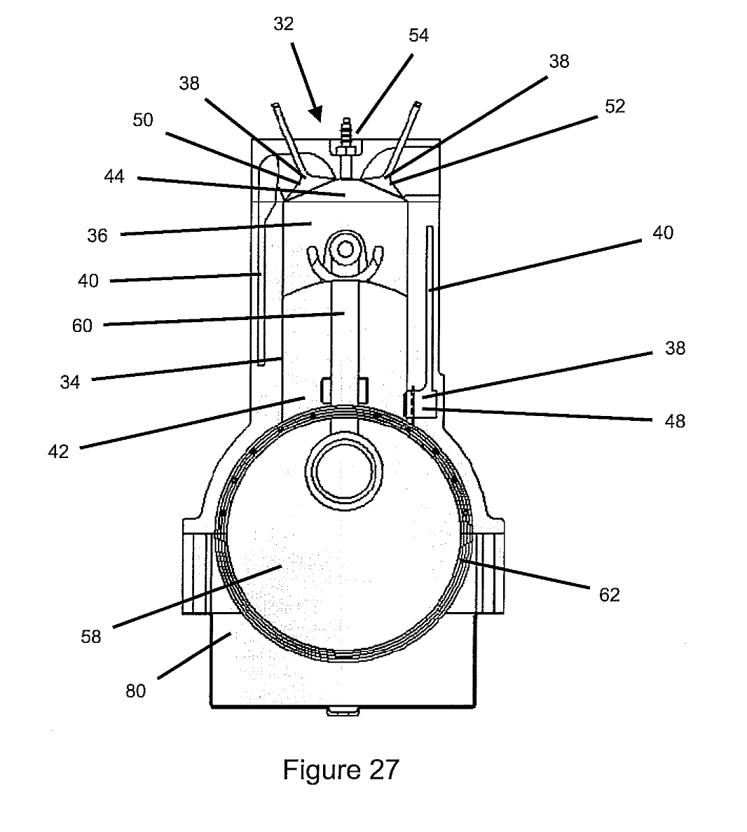

A combustion cycle of an internal combustion engine will now be described in terms of the exemplary embodiment detailed in the figures. It should be realized that a combustion cycle including the embodiment shown in FIGS. 25-27 including a crankshaft 58 and connecting rod 60 will operate in the same combustion process.

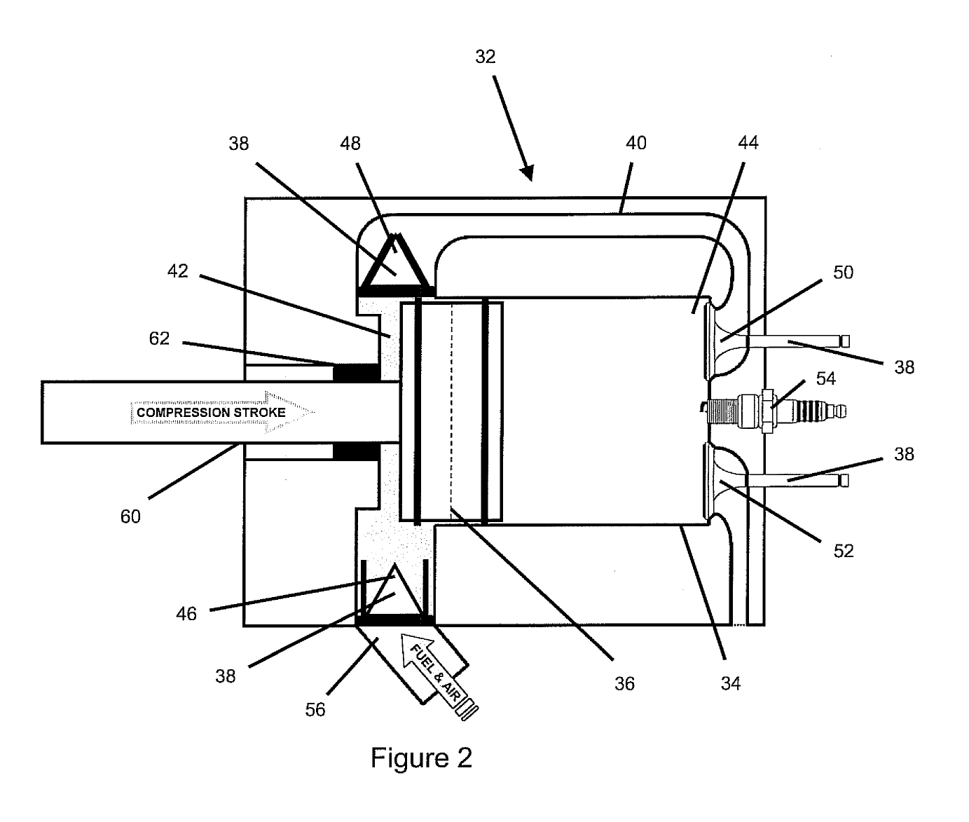

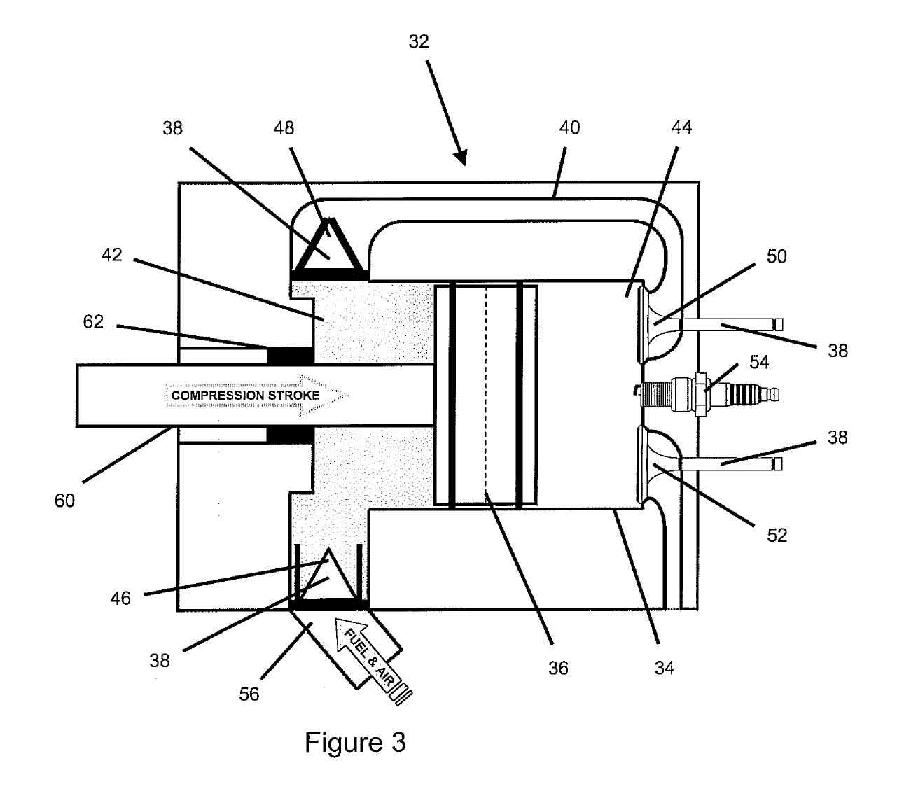

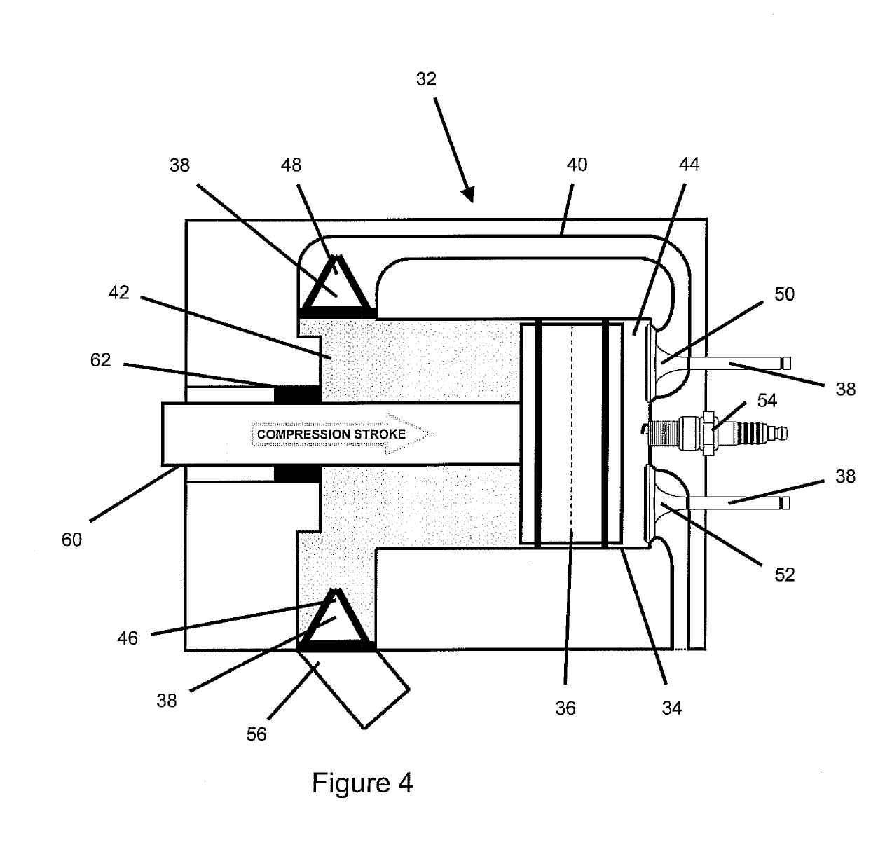

Referring to FIGS. 2-4, there is shown an initial compression stroke in which the first valve 46 is open allowing introduction of a fluid into an under piston volume 42. The second, third, and fourth valves 48, 50, 52 are all closed during the initial compression stroke.

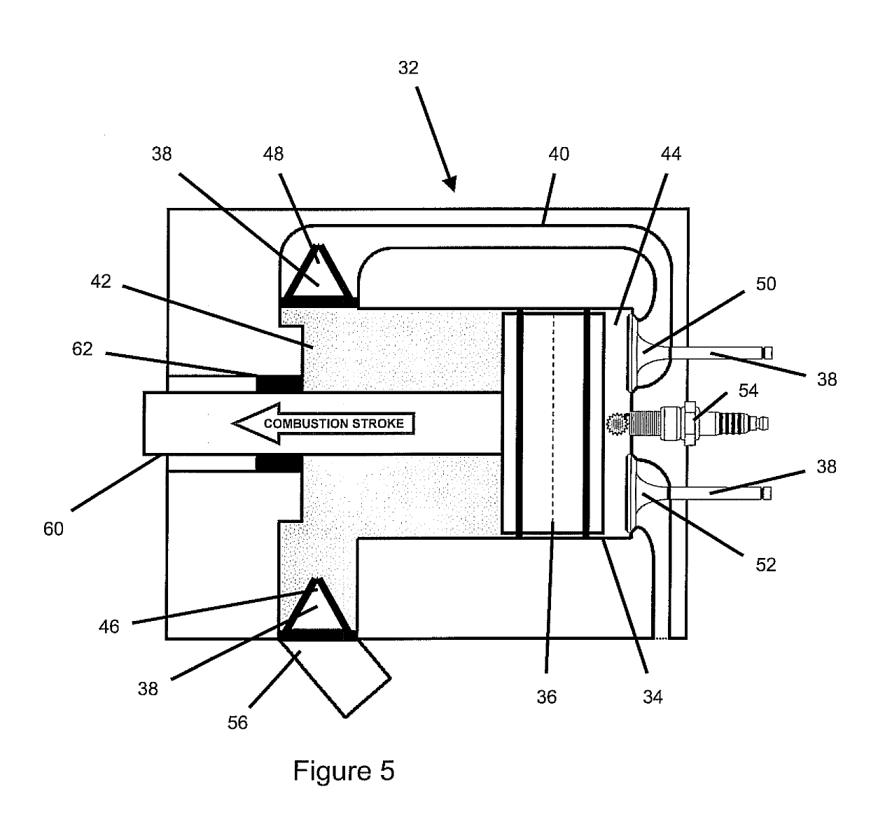

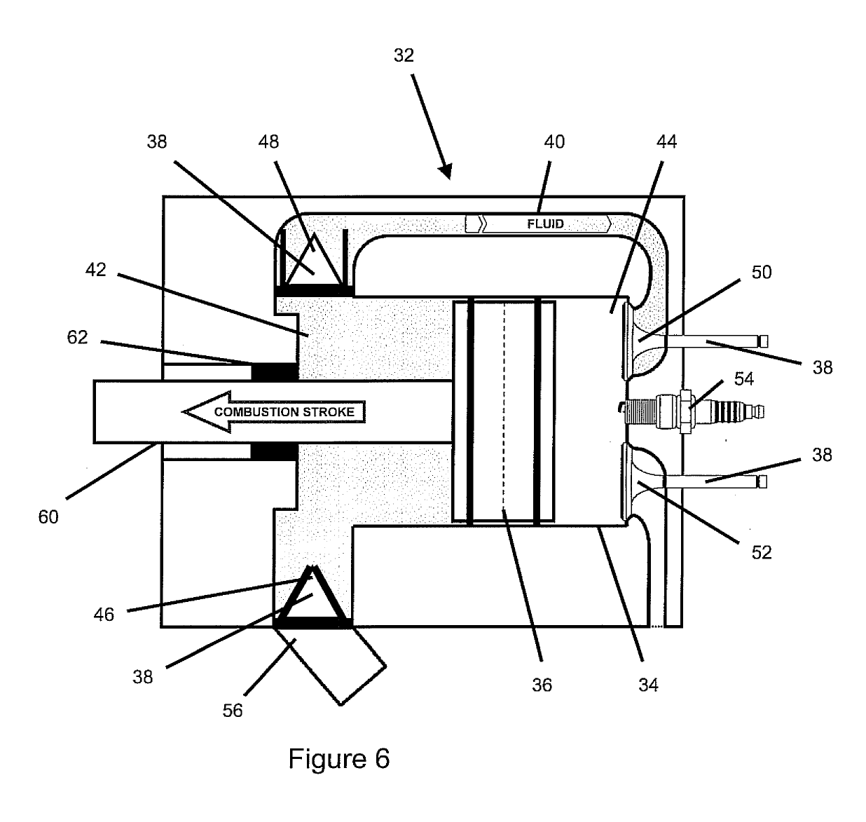

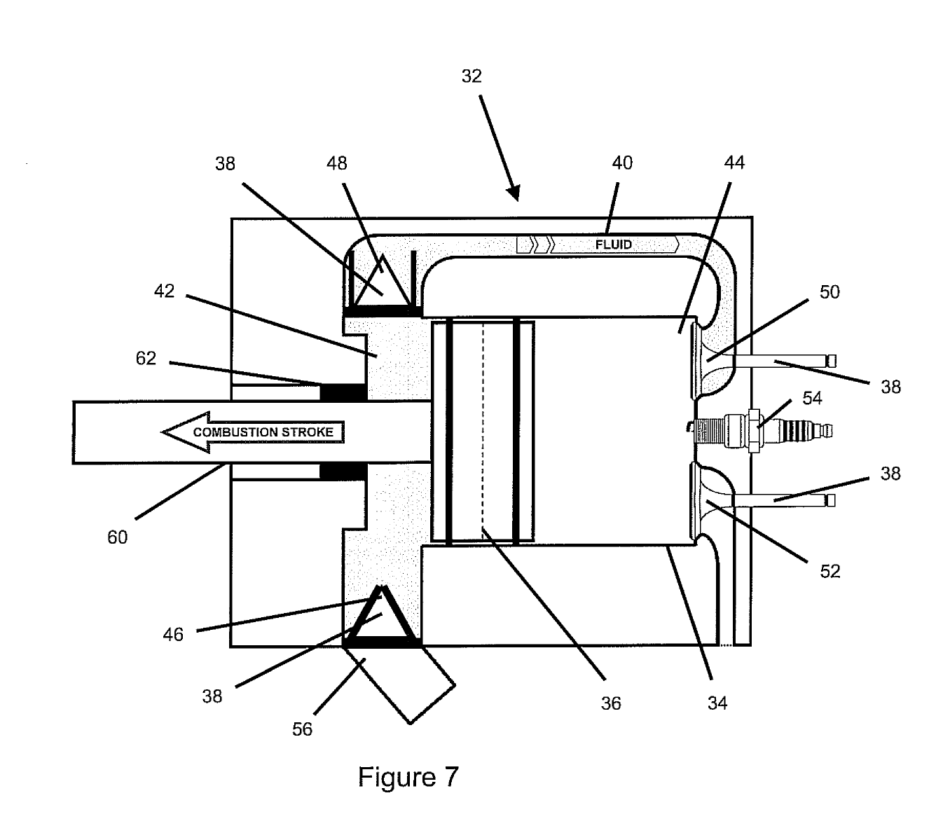

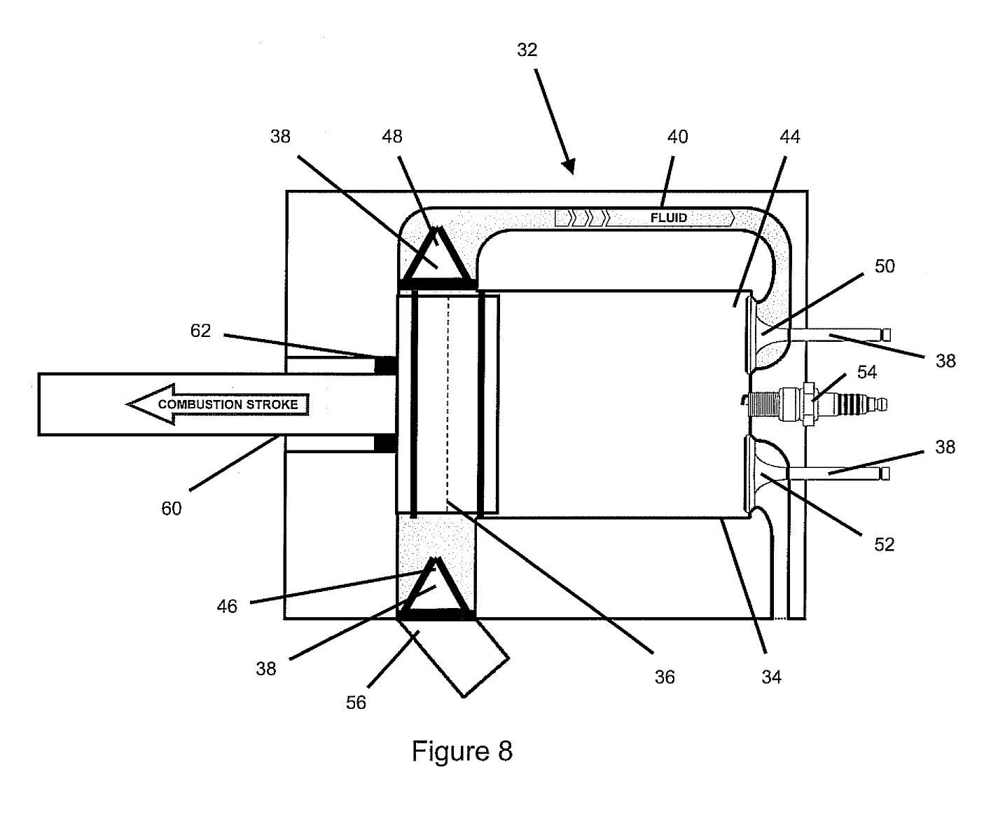

Referring to FIGS. 5-8, there is shown an initial combustion stroke including an ignition of a fluid positioned in an over piston volume 44 in which the piston 36 is driven downward in the direction of the arrow. The piston 36 drives the under piston volume 42 into an accumulation chamber 40 through the second valve 48 which is open. The first, third, and fourth valves 46, 50, 52 remain closed such that the under piston volume 42 is transferred into the accumulation chamber 40. After the piston 36 has reached the bottom end of its stroke, the second valve 48 is closed and the compressed fluid transferred from the under piston volume 42 remains in the accumulation chamber 40.

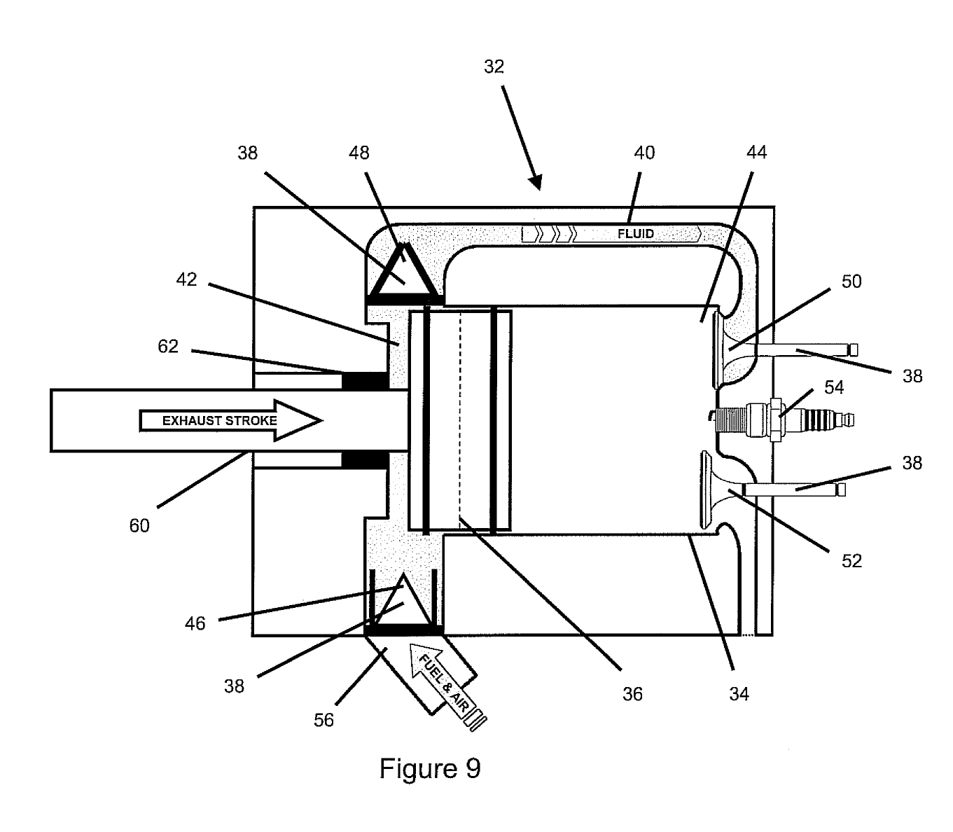

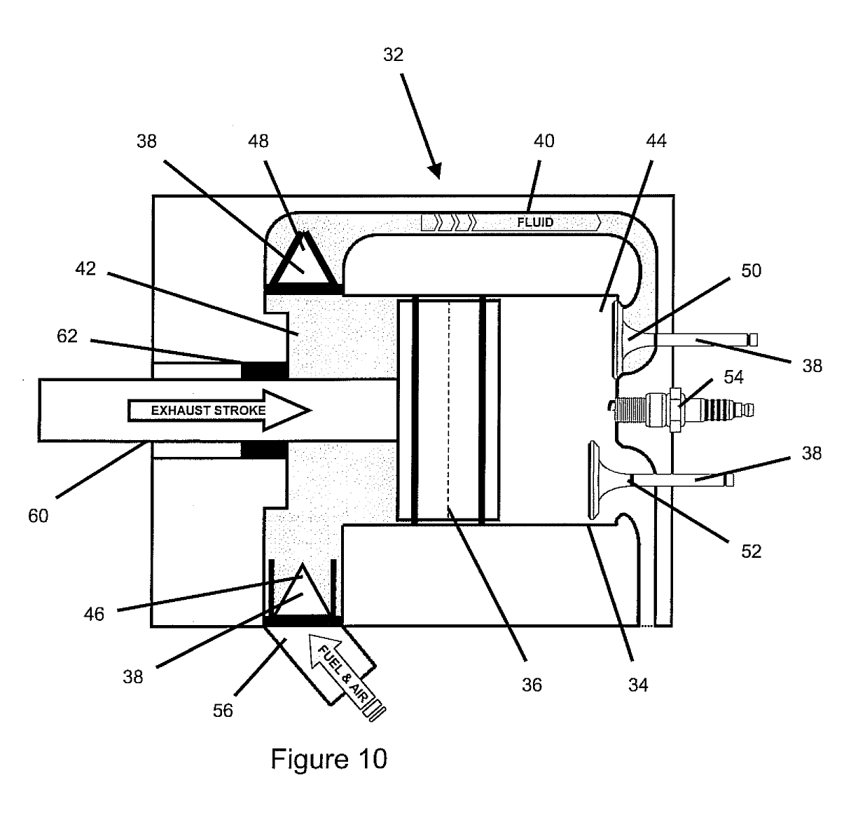

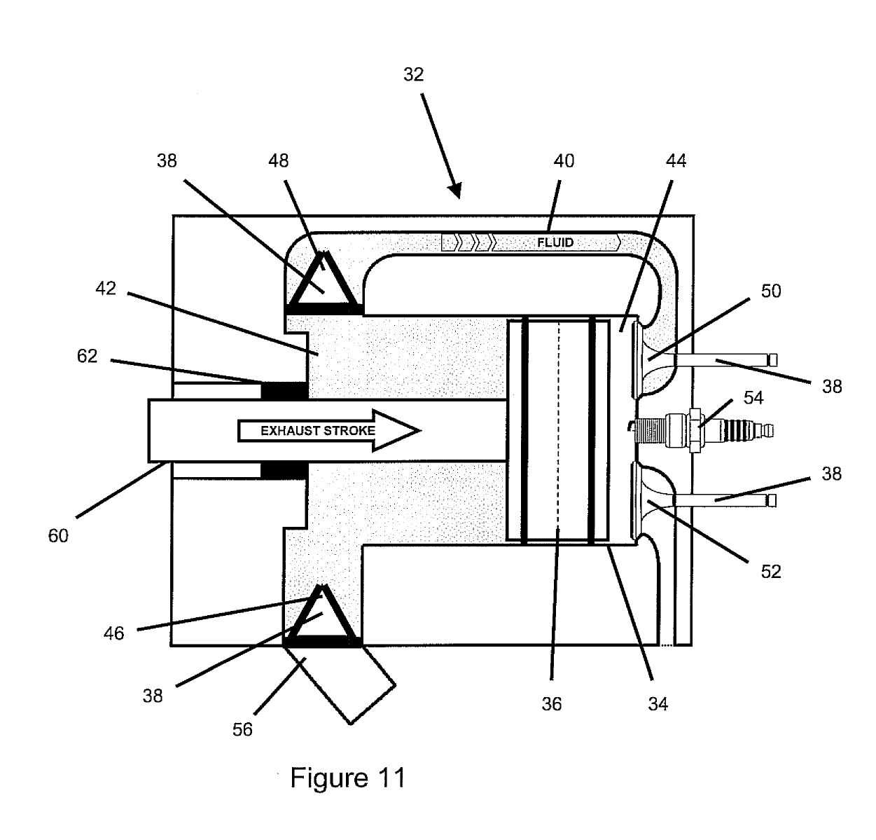

Referring to FIGS. 9-11, there is shown an exhaust stroke in which the fourth valve 52 is opened allowing exit of fluid from the over piston volume 44. Additionally, the first valve 46 is opened allowing entrance of a fluid into an under piston volume 42. As the piston 36 travels upward in the direction of the arrow, additional fluid is introduced into the under piston volume 42. At the end of the exhaust stroke, the fourth valve 52 is closed preventing further exit of fluid from the above piston volume 44, and the first valve 46 is closed preventing further entrance of fluid into the under piston volume 42.

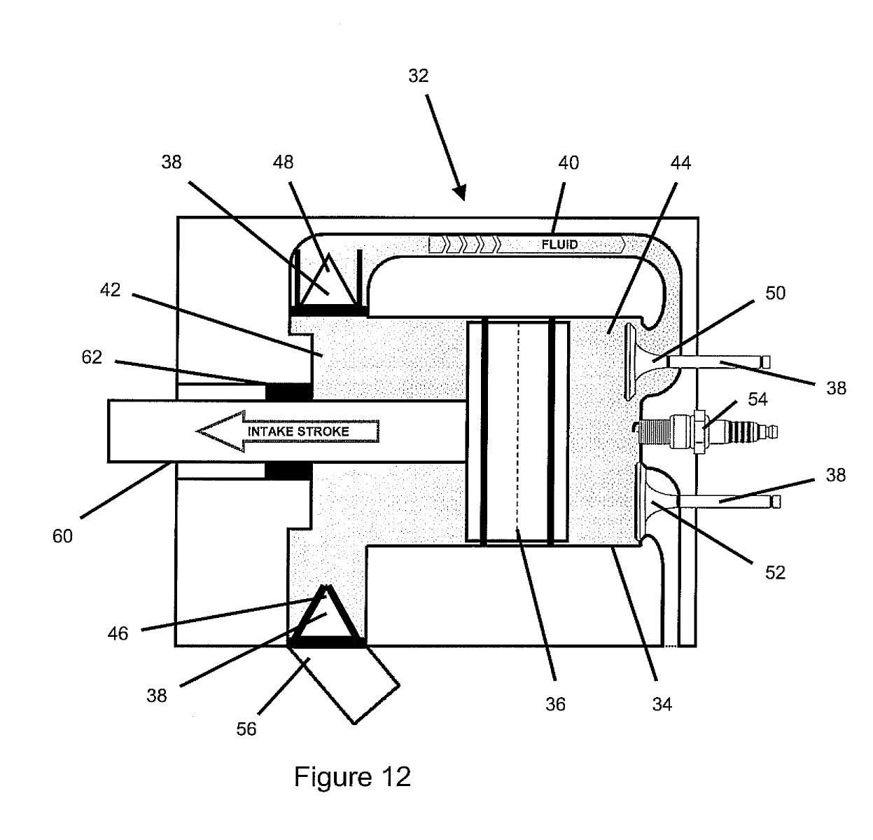

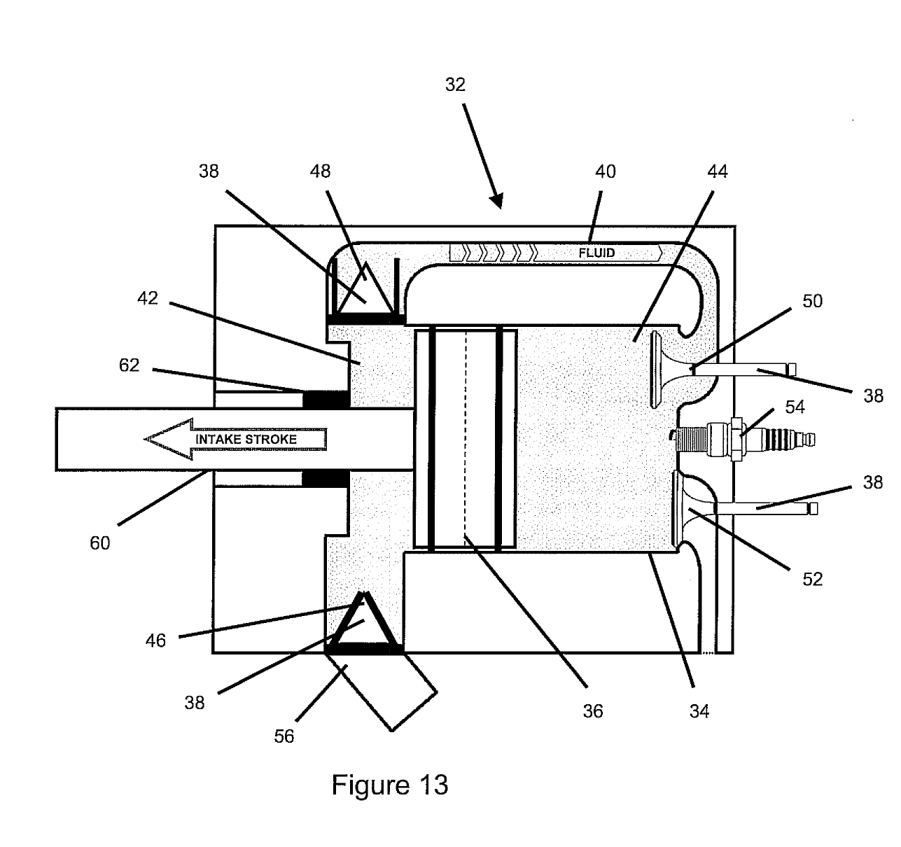

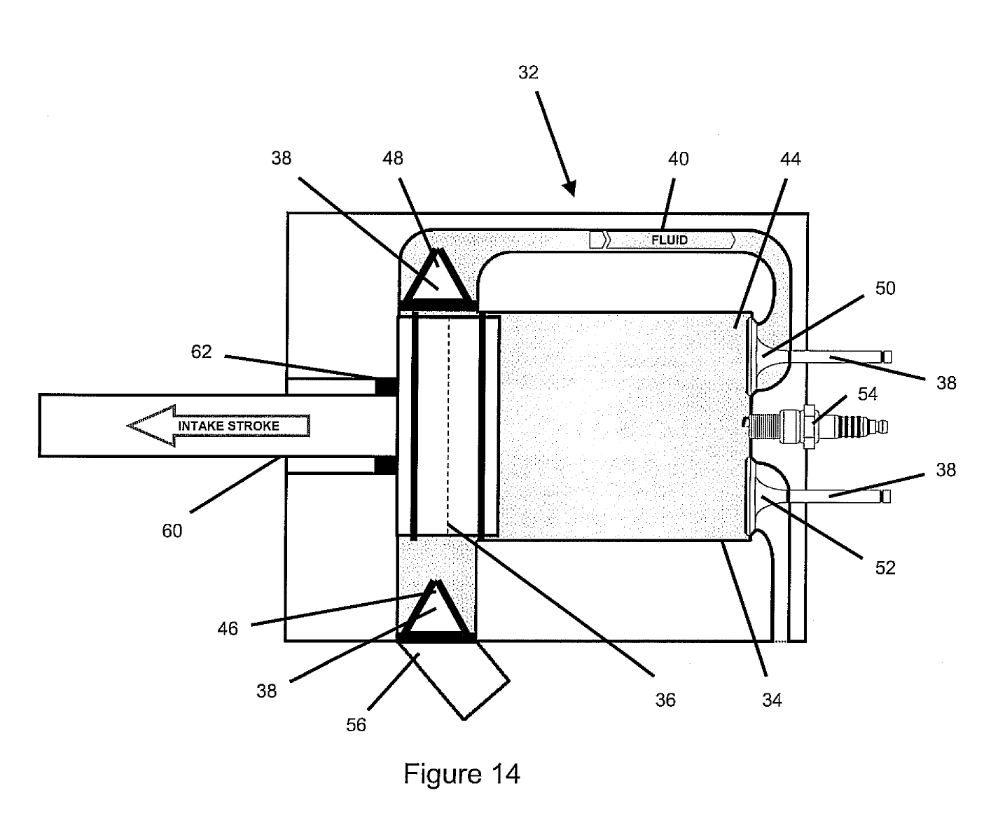

Referring to FIGS. 12-14, there is shown an intake stroke of an internal combustion engine. During the intake stroke, the piston 36 moves downward in the direction of the arrow and the second valve 48 is opened allowing transfer of compressed fluid from the under piston volume 42 into the accumulation chamber 40. Additionally, the third valve 50 is opened allowing introduction of compressed fluid from both the under piston volume 42 and accumulation chamber 40 to enter the above piston volume 44. The movement of the piston 36 in the downward direction of the arrow drives the fluid from the under piston volume 42 and accumulation chamber 40 into the above piston volume 44. At the end of the intake stroke, the first, second, third and fourth valves 46, 48, 50, 52 are all closed.

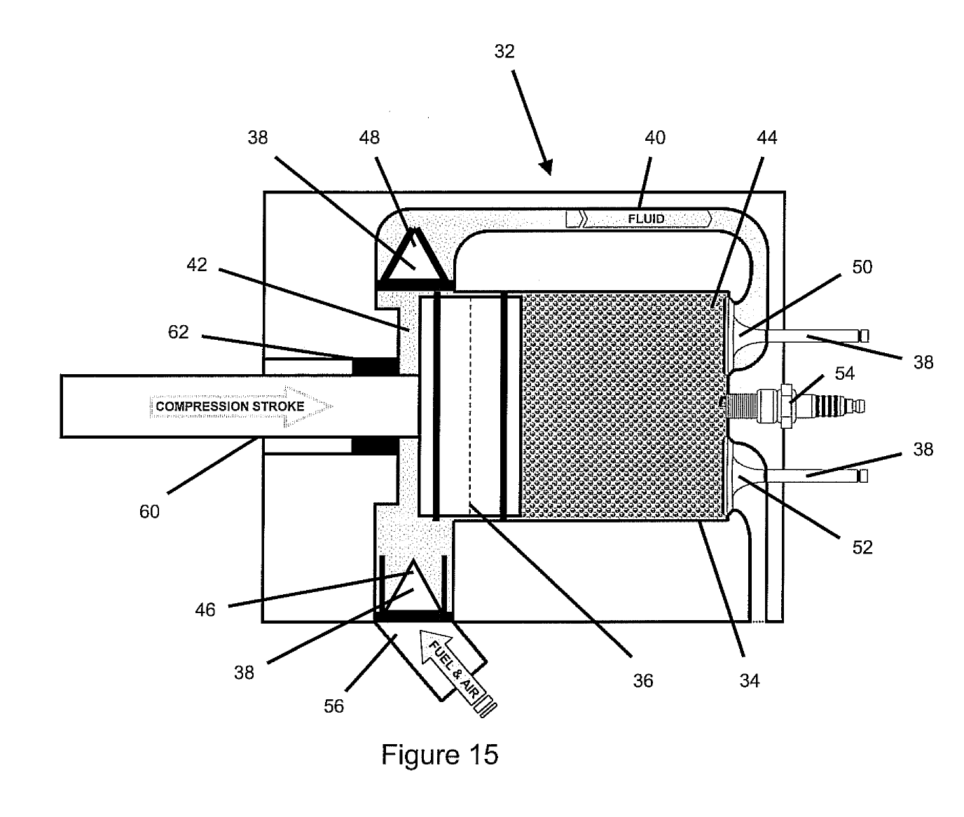

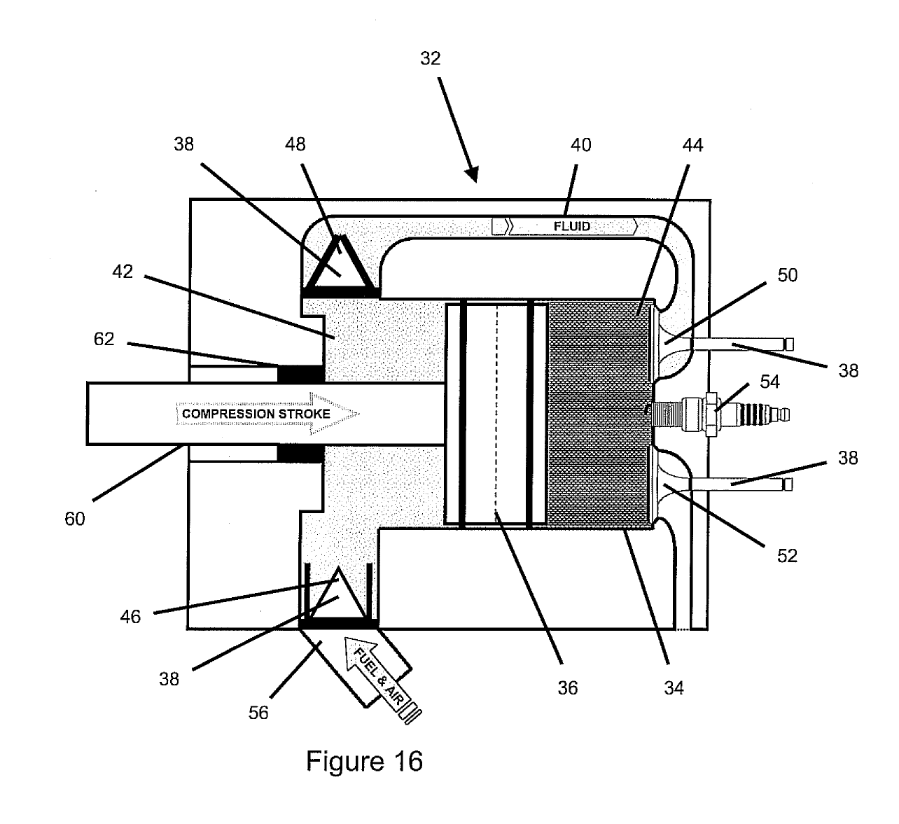

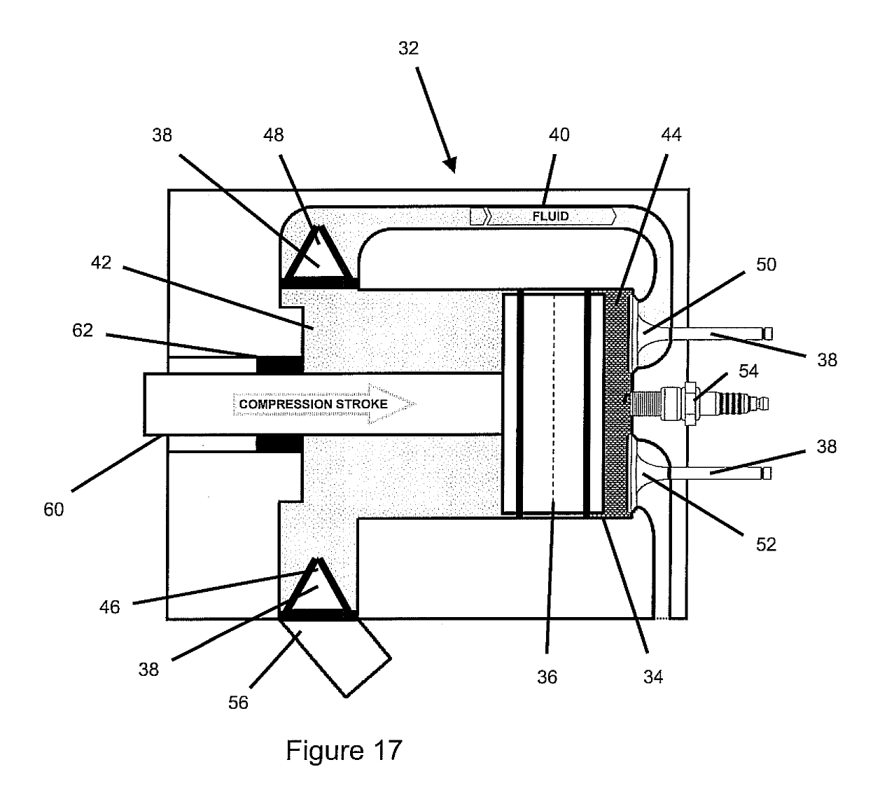

Referring to FIGS. 15-17, there is shown a compression stroke of the internal combustion engine in which the over piston volume 44 is compressed by upward movement of the piston 36 in the direction of the arrow. The first valve 46 is open allowing introduction of a fluid into the under piston volume 42 while the second, third, and fourth valves 48, 50, 52 remain closed. At the top end of the compression stroke the first valve 46 is closed preventing further introduction of fluid into an under piston volume 42.

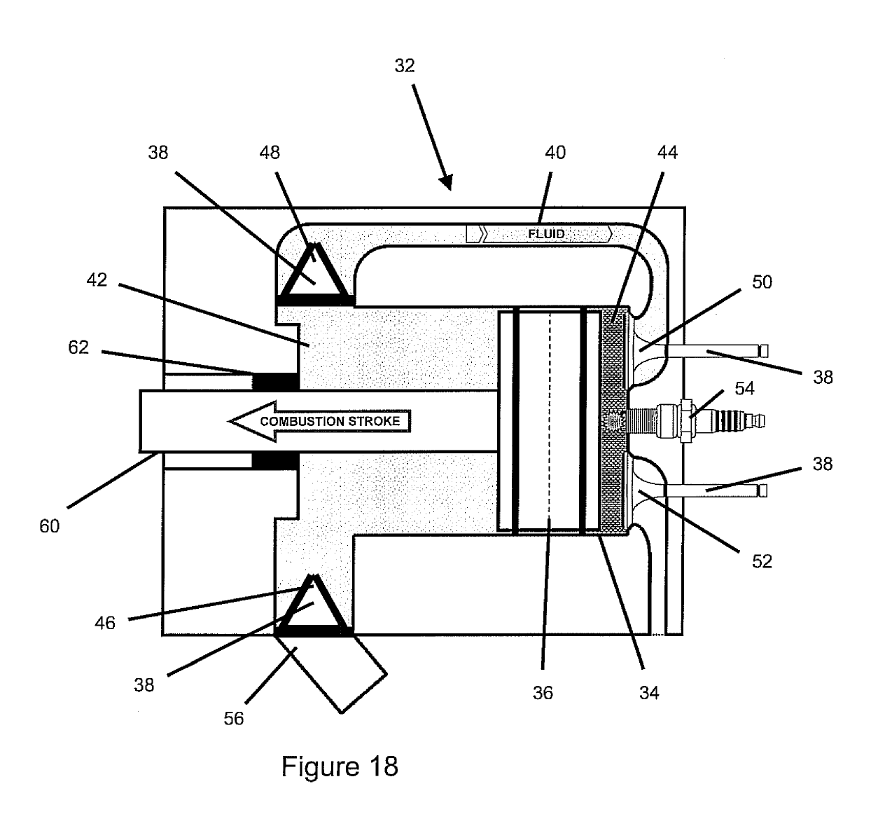

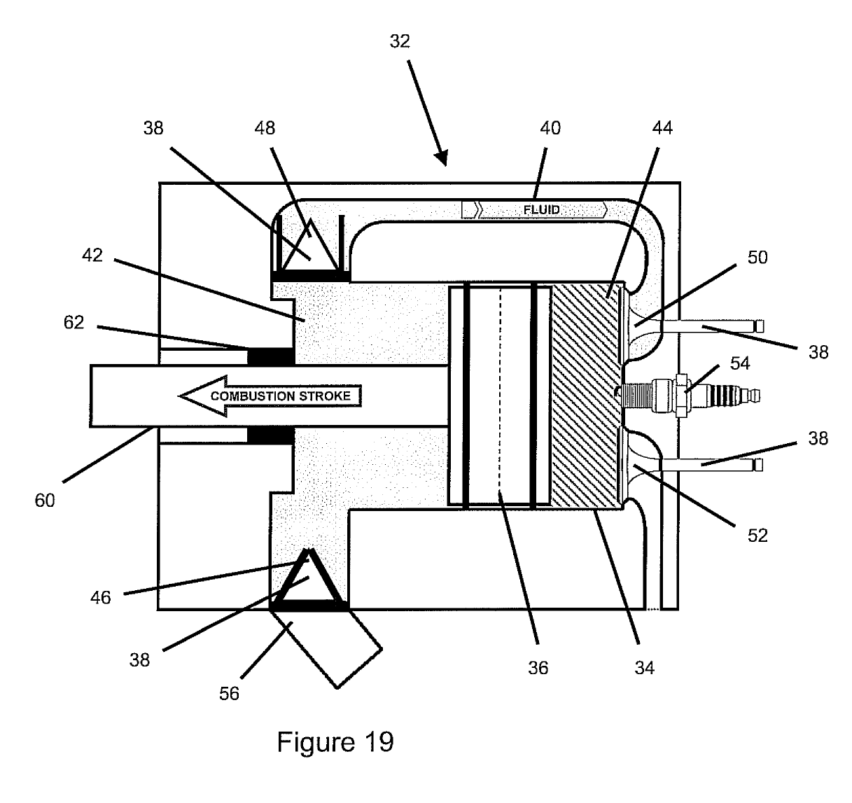

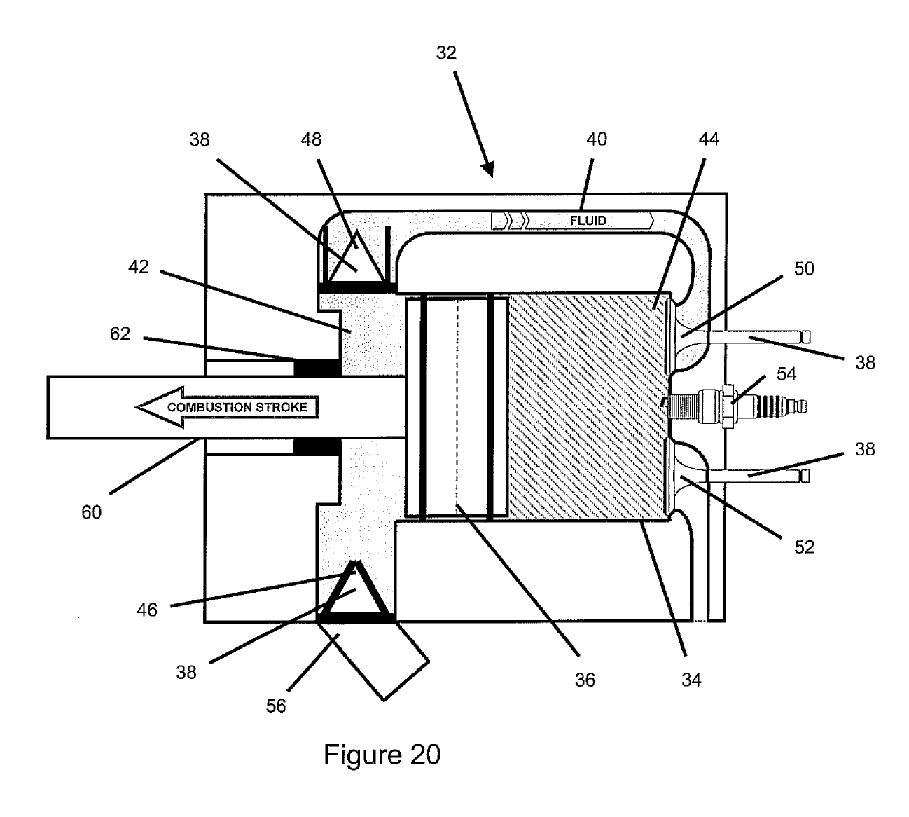

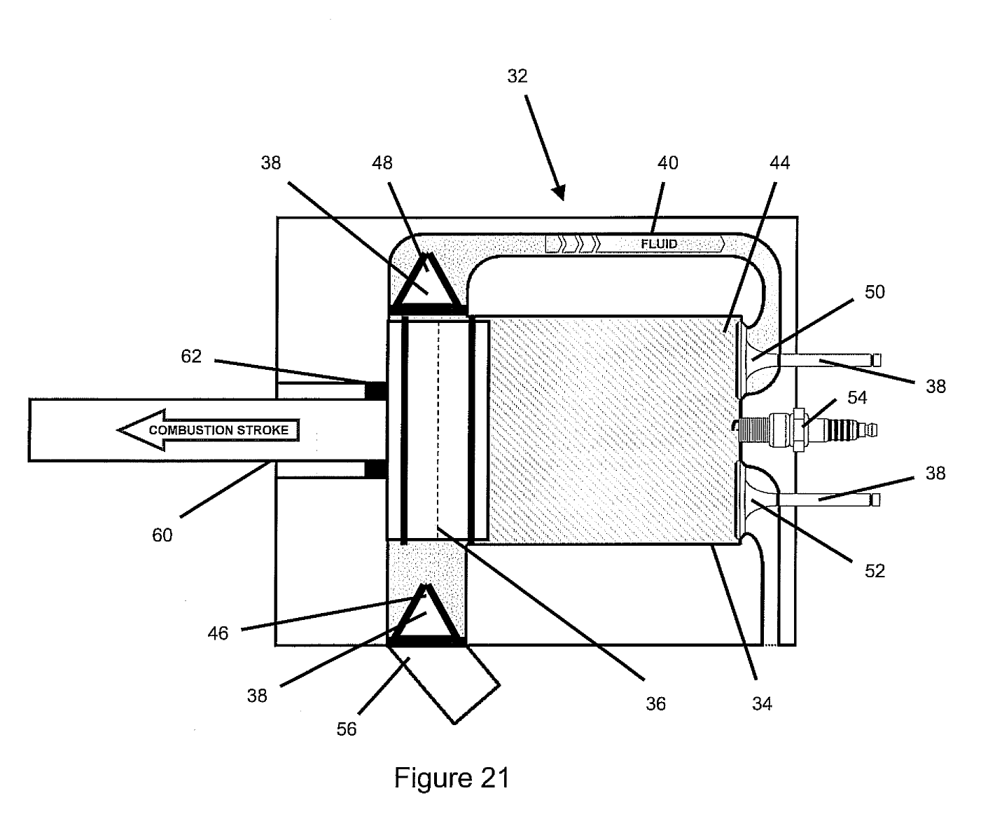

Referring to FIGS. 18-21, there is shown a combustion stroke of an internal combustion engine following the compression stroke of FIGS. 15-17. As can be seen in the figures, the piston 36 is driven downward in the direction of the arrow following ignition of the combustible fluid in the above piston volume 44. Following ignition, the fluid in the under piston volume 42 is driven by the piston 36 through the open second valve 48 into the accumulation chamber 40. The first, third, and fourth valves 46, 50, 52 remain closed. At the end of the combustion stroke, the second valve 48 is closed such that the fluid transferred from the under piston volume 42 remains compressed in the accumulation chamber 40.

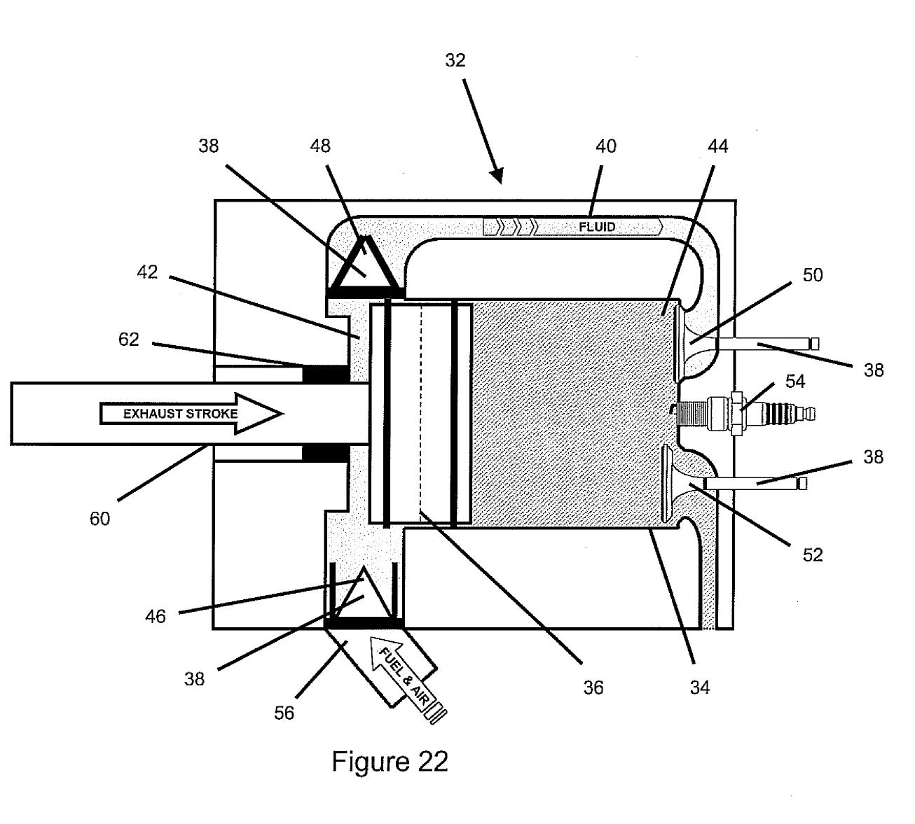

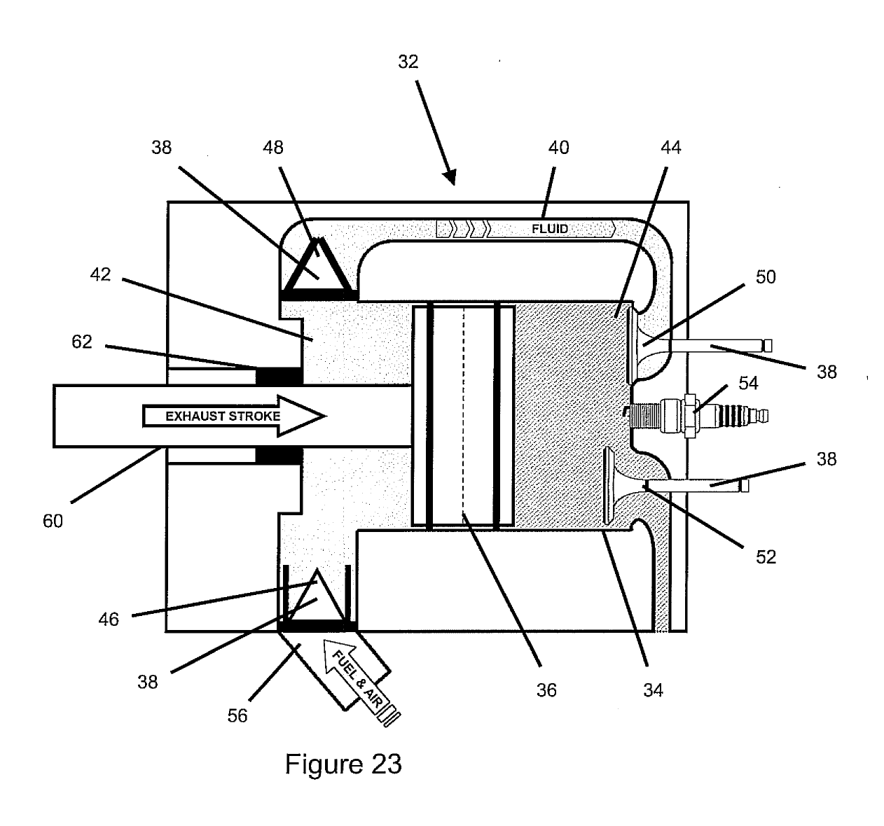

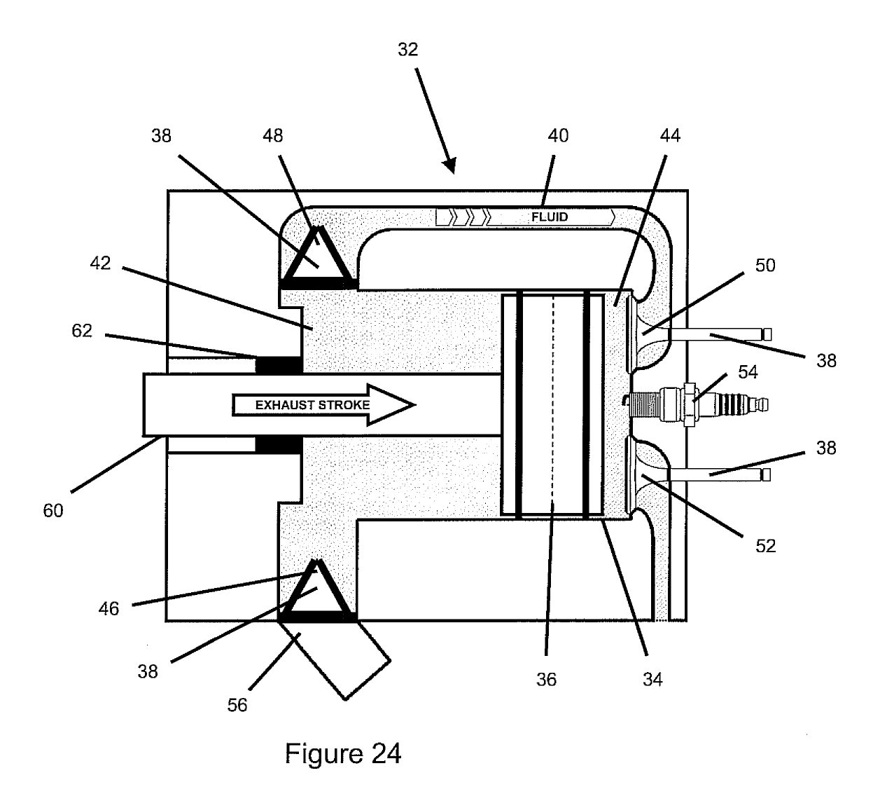

Referring to FIGS. 22-24, following the combustion stroke, the piston 36 is then moved upward through an exhaust stroke in the direction of the arrow. As the piston 36 moves in the direction of the arrow, the first valve 46 is opened allowing introduction of a fluid to an under piston volume 42. Additionally, the fourth valve 52 is opened allowing exit of fluid from the above piston volume 44 through an exhaust port. The piston 36 continues its travel until it reaches the top end of its stroke in which the first and fourth valves 46, 52 are closed. The exhaust stroke is followed by another intake stroke as detailed in FIGS. 12-14. In this manner, the above piston volume 44 receives two charges of fluid including fluid in the under piston volume 42 as well as fluid in the accumulation chamber 40 that is combined and introduced to the above piston volume 44 to increase an overall efficiency of the internal combustion engine.

1. A forced induction system for an internal combustion engine comprising:
at least one cylinder;
at least one piston positioned in the at least one cylinder;
valves linked with the cylinder allowing ingress and egress of a fluid;
at least one accumulation chamber external relative to the cylinder accommodating fluid exiting an under piston volume and entering an above piston volume;
wherein during a four-stroke combustion cycle of the engine, two charges of fluid from the under piston volume are introduced in an above piston volume during the intake stroke of the engine increasing an efficiency of the engine.

2. The forced induction system of claim 1 wherein the valves include at least one first valve linked with the cylinder and positioned below the piston allowing entrance of a fluid in an under piston volume, at least one second valve linked with both the cylinder and the at least one accumulation chamber and positioned below the piston allowing exit of a fluid from the under piston volume for entrance into an accumulation chamber volume, at least one third valve linked with both the cylinder and the at least one accumulation chamber and positioned above the piston allowing exit of fluid from the accumulation chamber for entrance into an above piston volume, and at least one fourth valve linked with the cylinder and positioned above the piston allowing exit of fluid from the above piston volume.

3. The forced induction system of claim 2 wherein the first, second, third and fourth valves may be selected from various types including reed, poppet and rotary valves.

4. The forced induction system of claim 1 including an ignition device positioned in the cylinder igniting a fluid within the cylinder.

5. The forced induction system of claim 1 including at least one fuel port formed in the cylinder allowing entrance of a fuel within the cylinder.

6. The forced induction system of claim 5 including a fuel port formed in the cylinder in the above piston volume.

7. The forced induction system of claim 5 including a fuel port formed in the cylinder in the under piston volume.

8. The forced induction system of claim 1 including a fuel port formed in the cylinder in the above piston volume and in the under piston volume.

9. The forced induction system of claim 1 including a crankshaft connected to a connecting rod linked with the piston.

10. The forced induction system of claim 1 including a plurality of cylinders and pistons wherein each piston and cylinder is isolated from another piston and cylinder.

11. The forced induction system of claim 1 including a sealing structure sealing the under piston volume from the crankcase volume.

12. The forced induction system of claim 11 wherein the sealing structure includes a seal positioned about a connecting rod.

13. The forced induction system of claim 1 wherein lubricant is supplied in the under piston volume.

14. The forced induction system of claim 1 wherein lubricant is supplied in a fuel mixture.

15. The forced induction system of claim 1 wherein lubricant is a fuel.

16. A forced induction system for an internal combustion engine comprising:
at least one cylinder;
at least one piston positioned in the at least one cylinder;
at least one first valve linked with the cylinder and positioned below the piston allowing entrance of a fluid in an under piston volume;
at least one second valve linked with both the cylinder and the at least one accumulation chamber and positioned below the piston allowing exit of a fluid in the under piston volume;
at least one accumulation chamber external relative to the cylinder accommodating fluid exiting the under piston volume;
at least one third valve linked with both the cylinder and the at least one accumulation chamber and positioned above the piston allowing transfer of a fluid from the accumulation chamber into an above piston volume;
at least one fourth valve linked with the cylinder and positioned above the piston allowing exit of fluid from the above piston volume;
wherein during a four-stroke combustion cycle of the engine, two fluid charges from an under piston volume are combined in the accumulator chamber and introduced into an above piston volume during the intake stroke of the engine, increasing an efficiency of the engine.
